(19) United States
(12) Patent Application Publication
(10) Pub. No.: US 2004/0128304 A1
(43) Pub. Date: Jul. 1, 2004

(54) Selective exposure of free time in group scheduling systems

(75) Inventor: Vaughn Theodore Rokosz, Newton, MA (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: International Business Machines Corporation, Armonk, NY

(21) Appl. No.: 10/331,413

(22) Filed: Dec. 30, 2002

(51) Int. Cl. G06F 17/00

(52) U.S. Cl. 707/102

(57) ABSTRACT

A system for selectively exposing free time in a group scheduling system. THe system can include a groupware system having a calendar of scheduled meetings between a multiplicity of groupware system users. A set of free time rules further can be provided. Each of the free time rules can specify whether to expose at least one of the scheduled meetings, or whether to hide the at least one scheduled meeting. Finally, a free time rule processor can be configured to expose individual ones of the scheduled meetings to requesting ones of the groupware system users based upon associated ones of the free time rules. Consequently, each exposure can permit a new meeting to be scheduled in lieu of each the exposed individual ones of the scheduled meetings.

### BACKGROUND OF THE INVENTION

1. Statement of the Technical Field

The present invention relates to the field of groupware, and more particularly to scheduling tasks in groupware.

2. Description of the Related Art

Conventional groupware includes among other important features, a group scheduling capability. Specifically, in conventional groupware, one user can schedule a task such as a meeting with one or more invited participants simply by proposing a time and date for the meeting. If the meeting itself, and more importantly, the proposed time and date for the meeting is acceptable to the invited participants, the invited participants can accept the proposed meeting and the groupware system can schedule the meeting in each of the respective calendars of the participants. Consequently, for each participant, their personal calendar will reflect the scheduled meeting at the accepted time and date.

Notably, many sophisticated groupware systems will automatically detect conflicts in the proposed time and date of a meeting. More particularly, where the user proposing the meeting selects a date and time which conflicts with another calendared or otherwise scheduled obligation of one or more of the invited participants, the groupware system can so notify the user of the conflict before the participants can be invited. As will be recognized by one skilled in the art, detecting a conflict simply can be a function of querying the respective tables of each participant and the user to detect a scheduled to-do, event or other task during the period proposed for the meeting.

In this regard, conventional groupware systems distinguish between a time frame which already has been allocated by a user, and a time frame which has yet to be allocated by a user. More particularly, several sophisticated groupware systems support a “free time” or “busy time” feature that allows a task scheduler intent upon scheduling a meeting to first determine whether the prospective invitees to the meeting have not other pressing commitments scheduled at the proposed meeting time. Nevertheless, not all pre-existing meetings are equivalent in importance.

Groupware users will recognized that it is not uncommon for the users to be invited to informational meetings, or for the users to schedule meetings that are of some interest, but remain of low priority. To that end, attendance at such meetings are considered optional in the mind of the user and, in some sense, the user might consider skipping the meeting if a more pressing matter were to emerge. Yet, conventional groupware scheduling systems offer only two choices when exposing the schedule of a groupware user: “free” or “busy”.

Conventionally, groupware users can mark a meeting as “tentative” or “private” in which case the time frame occupied by the meeting will show as free to everyone. In contrast, the outright acceptance of a meeting will result in the respective time frame being shown as busy. There are drawbacks to both of these approaches. Marking a meeting as tentative or private will result in other groupware participants seeing that time frame as free. Accordingly, those other groupware participants might therefore conclude that the user will be free to schedule a meeting at that time. Conversely, where the user accepts a meeting during a specified time slot, even where the meeting may be unimportant in the mind of the user, will result in others seeing the time slot as busy, though the user might be willing to skip that meeting under the right circumstances.

### SUMMARY OF THE INVENTION

The present invention addresses the deficiencies of prior art group scheduling systems and provides a novel and non-obvious system, method and apparatus for selective exposing free time in a group scheduling system. In a system of the present invention, a system for selectively exposing free time in a group scheduling system can include a groupware system having a calendar of scheduled meetings between a multiplicity of groupware system users. A set of free time rules further can be provided. Each of the free time rules can specify whether to expose at least one of the scheduled meetings, or whether to hide the at least one scheduled meeting. Finally, a free time rule processor can be configured to expose individual ones of the scheduled meetings to requesting ones of the groupware system users based upon associated ones of the free time rules. Consequently, each exposure can permit a new meeting to be scheduled in lieu of each the exposed individual ones of the scheduled meetings.

Notably, the free time rules can include rules based upon individual identities of the requesting ones of the groupware system users. Also, the free time rules can include rules based upon keywords included in query requests from the requesting ones of the groupware system users. The free time rules further can include rules based upon whether a groupware system user scheduled to attend the schedule meeting had been directly or indirectly invited to attend the scheduled meeting. Finally, the free time rules yet further can include rules based upon whether a groupware system user scheduled to attend the schedule meeting had initially requested scheduling of the meeting.

In a preferred aspect of the invention, each of the free time rules can be classified as one of a global level rule and a meeting level rule. Each global level rule can have application to all of the scheduled meetings. In contrast, each meeting level rule can have application only to a corresponding one of the scheduled meetings. In any event, a conflicts resolution processor can be coupled to the free time processor and programmed to resolve conflicts between individual ones of the free time rules when applied by the free time processor.

A method for selectively exposing free time in a group scheduling system can include receiving a request from a requesting group scheduling system user to schedule a meeting with at least one directly invited group scheduling system user for a specified purpose during a specified time slot. A meeting which previously had been scheduled during at least a portion of the specified time slot can be identified. Consequently, at least one free time rule can be applied to either one of the previously scheduled meeting or the requesting group scheduling system user to determine whether to expose the previously scheduled meeting as free time and not as scheduled time.

Notably, the method can further include the step of editing the request to specify a particular free time rule to be applied to the request during the applying step. Moreover, conflicting applications of the at least one free time rule can be identified; and, the identified conflicting applications can be resolved in favor of one of the conflicting applications by reference to a prioritization rule. Finally, the applying step can include both retrieving global free time rules which are to be applied to all requests; and, further retrieving meeting level free time rules which are specific to the previously scheduled meeting. Both can be applied to the previously scheduled meeting.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of an exemplary groupware system configured to selectively expose free time according to a set of free time rules; and,

FIG. 2 is a pictorial illustration of the groupware system of FIG. 1.

### DETAILED DESCRIPTION OF THE PREFERRED EMBODIMENTS

The present invention is a method and system for selectively exposing scheduled tasks in a groupware system. In accordance with the inventive arrangements, scheduled meetings for respective users of the groupware system may or may not be exposed to other users of the groupware system depending upon the perceived importance and “cancelability” of the scheduled meetings. To facilitate the determination of whether a scheduled meeting should be exposed as such, a set of “free time rules” can be defined to guide the exposure of individual ones of the scheduled meetings. Each free time rule can specify whether a time slot in the calendar of a particular user ought to appear vacant, depending upon either the identity of the requesting user, or the class of requesting user, or a set of keywords specified in a scheduled meeting within the time slot.

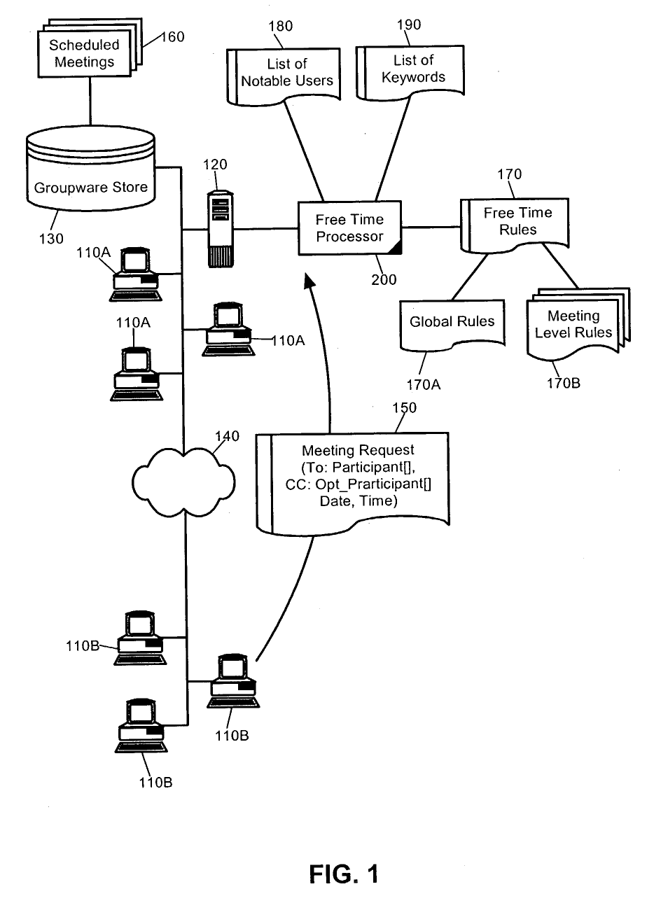

Notably, the method, system and apparatus of the present invention can have particular application to groupware systems in which meetings can be provisionally scheduled between different users in the groupware system. In this regard, FIG. 1 is a schematic illustration of an exemplary groupware system configured to selectively expose free time according to a set of free time rules. The exemplary groupware system can include at least one groupware system server 120, a multiplicity of groupware clients 110A, 110B and at least one data store 130 of groupware data such as scheduled meetings 160. Importantly, at least one of the groupware system servers 120 can be coupled to a free time processor 200.

Each of the groupware system servers 120, groupware clients 110A, 110B can be communicatively coupled to one another over a computer communications network. To that end, both local area networks and wide area networks, in addition to virtual private networks can be supported by way of a private Intranet, or global Internet 140. It will be recognized by one skilled in the art, however, that the invention is not so limited in consequence of the particular network architecture selected to host the groupware system of the present invention. Rather, the selection of architectures able to support the free time processor 200 can range from a standalone computing apparatus to a global network over which an application service provider (ASP) can process personal information management tasks for selected clients in the network.

In accordance with the inventive arrangements, a free time rule can be defined in a set of free time rules 170 and applied either globally as one of a set of global free time rules 170A, or individually in association with a particular meeting as one of a set of meeting-level free time rules 170B. The defined free time rule can be processed by the free time processor 200 to determine whether a given meeting among the scheduled meetings 160 ought to be exposed as free time to clients 110A, 110B of the groupware system, or whether the meeting ought to be exposed as busy time already occupied by a meeting. In this regard, the defined free time rule can specify a list of users 180 who are not to see the scheduled meeting, but rather who are to see the time slot of the meeting as free time.

Alternatively, the defined free time rule can specify a list of keywords 170 which, when included in specified text associated with a calendar request of a particular user, will cause the user to view the associated one of the scheduled meetings 160 to appear as free time. More specifically, where the query giving rise to the display of the calendar or the free time determination, such as a meeting request, included text having therein a specified one of the list of keywords 170, the scheduled time will be displayed as free time and not as a scheduled meeting. Examples of such queries can include, for instance, a request to schedule a meeting 150 during the time slot associated with the scheduled meeting.

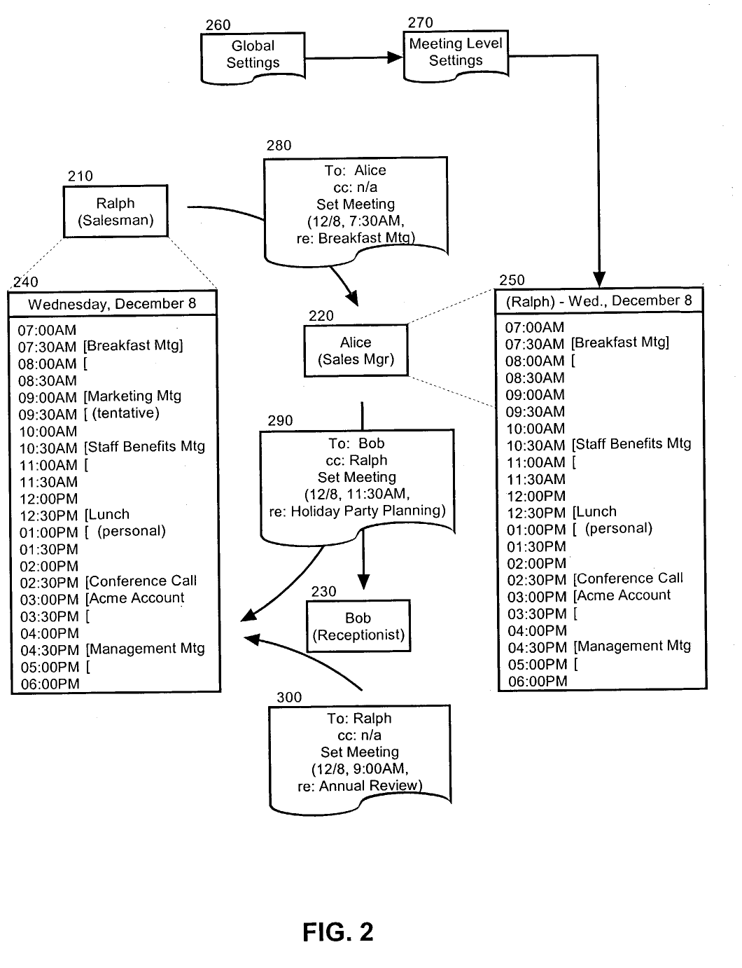

By way of illustrative example, FIG. 2 is a pictorial illustration of a groupware system in which three participants, Bob 230, Ralph 210 and Alice 220 collectively schedule meetings about the calendar 240 associated with Ralph 210. The calendar 240 includes six scheduled meetings: a breakfast meeting scheduled between 7:30 AM and 8:30 AM, a marketing meeting tentatively scheduled between 9:00 AM and 10:00 AM, a staff benefits meeting scheduled between 10:30 AM and 11:30 AM, lunch scheduled for one hour at 12:30 PM, a conference call scheduled between 2:30 PM and 3:30 PM, and a management meeting scheduled from 4:30 PM to 5:30 PM. Of these six scheduled meetings, the marketing meeting is considered tentative and definite, while lunch is considered to be a meeting which is personal in nature.

As Alice 220 and Bob 230 attempt to query the status of the calendar 240 for Ralph 210, depending upon both global settings 260 and meeting level settings 270, the exposed calendar may appear to have fewer scheduled meetings than that of the actual calendar 240. For instance, the global settings 260 may, by default, cause all scheduled meetings labeled as tentative to appear as free time. Consequently, without further guidance from other ones of the global settings 260 and the meeting level settings 270, the exposed calendar 250 as viewed by Alice 220 will appear to include free time between the hours of 9:00 AM and 10:00 AM, even though a tentative marketing meeting had been scheduled for this time slot.

Notably, the free time rules included as part of the global settings 270 and the meeting level settings 280 can include rules based upon the identity of a querying user. In this regard, as Alice 220 is a sales manager, while Bob 230 is a receptionist, a free time rule can be established which exposes less important scheduled meetings to persons of higher rank than others. In this way, when Alice 220 attempts to schedule a meeting with Ralph 210 during the time slot of 9:00 AM to 10:00 AM, the tentatively schedule marketing meeting having lesser importance than other scheduled meetings, will appear as free time to Alice 220 as Alice 220 is considered to outrank Ralph 210. By comparison, were Bob 230 to attempt to schedule a meeting with Ralph 210 during the time slot of 9:00 AM to 10:00 AM, the tentatively scheduled marketing meeting, though of lesser importance, would appear as a scheduled meeting as Ralph 210 is considered to outrank Bob 230.

Importantly, the free time rules included as part of the global settings 270 and the meeting level settings 280 can include rules based upon a list of keywords which, if such keywords appear in a meeting request, will cause the requested time slot to appear as free time. For instance, referring to FIG. 2, were Bob 230 to attempt to schedule a meeting 300 during the time slot 9:00 AM to 10:00 AM, under ordinary circumstances, the tentatively scheduled marketing meeting would appear to conflict with the meeting 300. Yet, as the narrative for the meeting 300 includes the work “Review”, the time slot 9:00 AM will appear to be free time as it can be presumed that meetings relating to the term “Review” may be of greater importance than other meetings.

In a preferred aspect of the invention, free time rules can be applied either within the global settings 260 or the meeting level settings 270 in which meetings scheduled by the user are to appear to all other users regardless of the nature of the scheduled meeting or the identity of other users querying the calendar. In particular, it can be inferred that scheduled meetings which are “chaired” by the user are deemed more important than would be the case if the user were merely an invitee.

Conversely, where the user is invited to attend a meeting not directly, but indirectly through carbon copy or some such similar method, it can be inferred that the meeting is not to be considered as important as would be the case were the user to have been invited directly. Accordingly, scheduled meetings arising from only an indirect invitation can be reflected as free time. Thus, as shown in FIG. 2, whether by way of global settings 260 or meeting level settings 270, where Alice 220 has invited Bob 230 to a Holiday Party Planning meeting, but where Alice 220 has only indirectly invited Ralph 210, the meeting, scheduled for 11:30 AM will not appear in the calendar 240.

Ordinarily, free time rules can be applied at the meeting level on a meeting by meeting basis. In this regard, each scheduled meeting can have applied thereto, a selection of one or more free time rules, ranging from show all to suppress all. Intermediate meeting level rules can include showing free time in lieu of scheduled meetings only to a selection of users, or showing free time in lieu of scheduled meetings only where a calendar query includes one or more specified keywords. Of course, each meeting level rule can be expressed globally across all meetings. Importantly, where two free time rules conflict as between the meeting level and global level, the meeting level rules are to take precedence over the global level rules. Similarly, in the event of a conflict between a meeting scheduled by one person in the list of persons to whom a time slot is to appear as free time, and requesting person, the order of priority can be determined based on the placement of both persons in the list of persons. Thus, where the querying person is listed in higher order than the person who scheduled a meeting at the queried time slot, the queried time slot will appear as free time.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A system for selectively exposing free time in a group scheduling system, the system comprising:
a groupware system comprising a calendar of scheduled meetings between a plurality of groupware system users;
a set of free time rules, each of said free time rules specifying whether to expose at least one of said scheduled meetings, or whether to hide said at least one scheduled meeting; and,
a free time rule processor configured to expose individual ones of said scheduled meetings to requesting ones of said groupware system users based upon associated ones of said free time rules, each said exposure permitting a new meeting to be scheduled in lieu of each said exposed individual ones of said scheduled meetings.

2. The system of claim 1, wherein said free time rules comprise rules based upon individual identities of said requesting ones of said groupware system users.

3. The system of claim 1, wherein said free time rules comprise rules based upon keywords included in query requests from said requesting ones of said groupware system users.

4. The system of claim 1, wherein said free time rules comprises rules based upon whether a groupware system user scheduled to attend said at least one of said schedule meetings had been directly or indirectly invited to attend said at least one of said scheduled meetings.

5. The system of claim 1, wherein said free time rules comprises rules based upon whether a groupware system user scheduled to attend said at least one of said schedule meetings had initially requested that said at least one of said scheduled meetings be scheduled.

6. The system of claim 1, wherein each of said free time rules are classified as one of a global level rule and a meeting level rule, each said global level rule having application to all of said scheduled meetings, each said meeting level rule having application only to a corresponding one of said scheduled meetings.

7. The system of claim 1, further comprising a conflicts resolution processor coupled to said free time processor and programmed to resolve conflicts between individual ones of said free time rules when applied by said free time processor.

8. A method for selectively exposing free time in a group scheduling system, the method comprising the steps of:
receiving a request from a requesting group scheduling system user to schedule a meeting with at least one directly invited group scheduling system user for a specified purpose during a specified time slot;
identifying a previously scheduled meeting during at least a portion of said specified time slot; and,
applying at least one free time rule to one of said previously scheduled meeting and said requesting group scheduling system user to determine whether to expose said previously scheduled meeting as free time and not as scheduled time.

9. The method of claim 8, further comprising the step of editing said request to specify a particular free time rule to be applied to said request during said applying step.

10. The method of claim 8, further comprising the steps of:
identifying conflicting applications of said at least one free time rule; and,
resolving said identified conflicting applications in favor of one of said conflicting applications by reference to a prioritization rule.

11. The method of claim 8, wherein said applying step comprises the steps of:
retrieving global free time rules which are to be applied to all requests;
further retrieving meeting level free time rules which are specific to said previously scheduled meeting; and,
applying both said global free time rules and said meeting level free time rules to said previously scheduled meeting.

12. A machine readable storage having stored thereon a computer program for selectively exposing free time in a group scheduling system, the computer program comprising a routine set of instructions for causing the machine to perform the steps of:
receiving a request from a requesting group scheduling system user to schedule a meeting with at least one directly invited group scheduling system user for a specified purpose during a specified time slot;
identifying a previously scheduled meeting during at least a portion of said specified time slot; and,
applying at least one free time rule to one of said previously scheduled meeting and said requesting group scheduling system user to determine whether to expose said previously scheduled meeting as free time and not as scheduled time.

13. The machine readable storage of claim 12, further comprising the step of editing said request to specify a particular free time rule to be applied to said request during said applying step.

14. The machine readable storage of claim 12, further comprising the steps of:
identifying conflicting applications of said at least one free time rule; and,
resolving said identified conflicting applications in favor of one of said conflicting applications by reference to a prioritization rule.

15. The machine readable storage of claim 12, wherein said applying step comprises the steps of:
retrieving global free time rules which are to be applied to all requests;
further retrieving meeting level free time rules which are specific to said previously scheduled meeting; and,
applying both said global free time rules and said meeting level free time rules to said previously scheduled meeting.
